(19) United States
(12) Patent Application Publication
(10) Pub. No.: US 2007/0109505 A1
(43) Pub. Date: May 17, 2007

(54) PROJECTION THREE-DIMENSIONAL DISPLAY APPARATUS

(75) Inventors: Takashi Kubara, Fukuoka (JP); Takashi Hirabara, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/538,533

(22) Filed: Oct. 4, 2006

(30) Foreign Application Priority Data
Oct. 5, 2005 (JP) P. 2005-292239
Oct. 5, 2005 (JP) P. 2005-292240
Oct. 6, 2005 (JP) P. 2005-293614

(51) Int. Cl. G03B 21/14

(52) U.S. Cl. 353/69

(57) ABSTRACT

A screen for imaging a group picture of view point pictures is arranged and a screen shake detecting means and a means for correcting and controlling the group picture of the view point pictures projected on a screen to a proper position are provided.

### BACKGROUND OF THE INVENTION

The present invention relates to a projection three-dimensional display apparatus capable of performing a three-dimensional display used in an image technology field, an amusement field, an entertainment field, an internet field, an information field, a multimedia field, a communication field, an advertisement and propaganda field, a medical field, an art field, an education field, a design supporting field, a simulation field, a virtual reality field, and the like.

In past, as a means for displaying three-dimensional picture information, there have been a naked eye stereoscopic parallelism method viewing a right picture at a right eye and a left picture at a left eye with respect to two sheets of pictures with binocular parallax, a stereoscope method viewing the pictures using glasses attached with a liquid crystal shutter or different lenses for each of a right eye and a left eye, and an anaglyph method viewing binocular parallax pictures with color difference in red and blue using stereo glasses. However, when viewing three-dimensional pictures using the above methods, special glasses or training is needed.

In recent, liquid crystal displays capable of performing a three-dimensional display not having glasses have continuously been developed. Most of them are a three-dimensional liquid crystal display element not having glasses based on an image splitter method, so called, a three-dimensional picture display apparatus with only horizontal parallax based on a parallax barrier method or a lenticular lens method. The three-dimensional display apparatus based on the parallax barrier method or the lenticular lens method creates a three-dimensional effect by spatially separating and providing a picture optical path so that a right picture can be viewed from a right-eye position and a left picture from a left-eye position. As a result, the picture optical path is periodically separated and provided to the right-eye position and the left-eye position in the space such that if the positions are deviated, the three-dimensional effect is ruptured. In principle, there is a problem that if the right-eye position and the left-eye position are deviated from a horizontal direction, the three-dimensional effect is ruptured because the picture including parallax of a horizontal direction is provided. Accordingly, it is necessary to fix the right-eye position and the left-eye position to a regular position in the space in order to perform the stereoscopic display while keeping the three-dimensional effect of the three-dimensional moving picture for a long time.

As for the deviation of the right-eye position and the left-eye position from the horizontal direction, it has been devised a method for controlling and modifying the picture optical path by conforming the position of an viewer's eye or face to the deviation of the positions by a sensor. However, it causes troublesome problems that the size of the apparatus becomes large and a marker must be attached to the viewer in order to sense the position of the viewer's eye or face.

In recent years, in order to overcome the problems there has been proposed a three-dimensional display method using a two-dimensional display panel such as a liquid crystal, etc., and a pinhole array or a fly's eye lens array instead of a film, which improves an integral photography proposed in 1908 by M. G. Lipmann (for example, see Patent Document 1).

In order to display a smooth three-dimension using the integral photography, it is necessary to arrange points regarding different parallax pictures in one pinhole or a lens. For example, in order to display 10 parallax pictures in a horizontal direction and a vertical direction, respectively, a need exists for 100 pictures as 10 by 10. Therefore, there is a problem that when performing a three-dimensional display, the resolution of a two-dimensional display panel is degraded to 1/100 in resolution.

In order to prevent the degradation of the resolution, there is a method for reducing the number of the parallax pictures; however, as the number of the parallax becomes small, the movement of the smooth parallax is not made, degrading a three-dimensional effect.

For this reason, a need exists for a high resolution of a two-dimensional display panel in order to obtain a good three-dimensional picture while keeping a three-dimensional effect and resolution. In recent, due to the development of a liquid crystal panel and a plasma display panel, a large size and high resolution of a display panel has been developed. Here, it may be considered that the two-dimensional display panel for displaying three-dimensional pictures is realized as a liquid crystal panel of 10.4 inches having 158.4 mm in length and 211.2 mm in breadth. As an example, when realizing a three-dimensional picture with 10 parallaxes in length and 10 parallaxes in breadth using a convex lens array or a pinhole array of 1 mm in resolution, that is, 1 mm in diameter, the liquid crystal panel of 10.4 inches requires 1584 pixels in length and 211 pixels in breadth, wherein the pixel pitch of the liquid crystal panel becomes 254 dpi (dot/inch). Upon considering that the highest resolution of the liquid crystal panel practically used until now is about 200 dpi, it is very difficult to realize a high picture quality of a three-dimensional picture display of the integral photography method using the liquid crystal panel or the plasma display panel.

As other one trend of a large-screen display apparatus such as the liquid crystal or the plasma display, and the like, there has been developed a large-screen display apparatus using a projector method. A rear projection-type display method, which performs the projector projection from a rear, is referred to as a rear projection television and has been spotlighted as one of the large-screen display methods. A DMD (Digital Micro Mirror Device) used in the rear projection television or a pixel type of a small display element such as a transmission-type liquid crystal, a reflective-type liquid crystal, and the like has significantly improved front brightness, uniformity of a screen, resolution, etc. Accordingly, the use of the projection-type display apparatus can easily display the three-dimensional pictures, compared with the integral photography method using the liquid crystal panel or the plasma display panel in the prior art. As an example of the projection-type display apparatus in the prior art, there is a multi projection-type stereoscopic image display apparatus described in JP-A-2003-279894.

Patent Document 1: Japanese Unexamined Patent Application Publication No. 2001-275134

In the projection-type stereoscopic display apparatus, when displaying a three-dimensional picture with 10 parallaxes in length and 10 parallaxes in breadth using a convex lens array or a pinhole array of 1 mm in resolution, that is, 1 mm in diameter within a display region, the resolution of 1 parallax is 0.1 mm and the pixel pitch is 254 dpi (dot/inch). Therefore, it is also necessary for an alignment error of the projection picture and the lens array to be 0.1 mm or less. If the alignment error between the projection picture and the lens array becomes large, image distortion imaged on a space by the lens becomes large so that the contrast of the picture displayed is degraded to deteriorate picture quality and resolution in space projection. Thereby, it is difficult to stereoscopically display the picture so that reality sense cannot be given as if there are the realities in the space.

However, in the projection-type stereoscopic display apparatus, it is very difficult to completely fix the projection apparatus and the screen, and in general, the vibration of the screen fixed occurs due to a vibration in an installation place to make the projection picture projected by the projection apparatus vibrate so that it is impossible to obtain the alignment of the projection picture and the lens array.

### SUMMARY

The present invention is proposed to solve the above problems. It is an object of the invention to provide a projection-type three-dimensional display apparatus comprising a means for detecting the shake of a screen and for correcting and controlling a group picture of view point pictures to a proper position based on the detected result to improve contrast of a display picture so that the deterioration of picture quality and resolution in space projection can be prevented and a three-dimensional effect given, thereby giving reality sense as if there is the realities in a space.

In other to achieve the object, a projection-type three-dimensional display apparatus comprising a means for controlling and imaging rays of light constituting view point pictures to emit the rays of light constituting the view point pictures including parallax information on view points from a surface of a three-dimensional picture arranged in a space and arranging the view point pictures including a plurality of parallax information on a two-dimensional plane corresponding to the respective imaging means, characterizing by comprising: a means for projecting a group picture of view point pictures including the plurality of parallax information and a screen for imaging the group picture of view point pictures, as a means for arranging the group picture of view point pictures including the plurality of parallax information, which are arranged just behind the means for controlling and imaging the rays of light; a means for detecting the shake of the screen; and a means for correcting and controlling the group picture of view point pictures projected on the screen to a proper position.

According to the present invention, by detecting the shake of the screen and correcting and controlling the group picture of view point pictures to a proper position based on the detected result, the alignment error between the projection picture and the lens array is able to be 0.1 mm or less. As a result, the contrast of the display picture is improved so that the deterioration of picture quality and resolution in space projection can be prevented and a three-dimensional effect given, thereby giving reality sense as if there is the realities in a space.

### BRIEF DESCRIPTION OF THE DRAWINGS

FIG. 1 is a view for explaining an embodiment 1 of a projection-type three-dimensional display apparatus according to the present invention;

FIG. 2 is a view for explaining an integral photography method;

FIG. 3 is a view for explaining an optical means adjusting a ray of light by moving a portion of a lens according to the present invention;

FIG. 4 is a view for explaining an embodiment 2 of a projection-type three-dimensional display apparatus according to the present invention;

FIG. 5 is a view for explaining an embodiment 3 of a projection-type three-dimensional display apparatus according to the present invention;

FIG. 6 is a view for explaining a shape of a wedge-type reflective plate according to the present invention;

FIG. 7 is a view for explaining a principle adjusting a ray of light by a wedge-type reflective plate and a projecting device according to the present invention;

FIG. 8 is a view for explaining a stereoscopic image display apparatus displaying a stereoscopic image using a stereoscopic image's element picture preparing method according to an embodiment 4 of the present invention;

FIG. 9 is a view illustrating the process of the stereoscopic image's element picture preparing method according to the embodiment 4 of the present invention;

FIG. 10 is a cross-sectional view viewed from A direction;

FIG. 11 is a cross-sectional view viewed from A direction in FIG. 8;

FIG. 12 is a view illustrating a display state of two-dimensional display pixels according to the embodiment 4 of the present invention;

FIG. 13 a view for explaining a display state of two-dimensional display pixels when using a high resolution of a two-dimensional picture display device according to the embodiment 4 of the present invention;

FIG. 14 is a view for explaining a stereoscopic display apparatus displaying a stereoscopic image using a stereoscopic image's element picture preparing method according to an embodiment 5 of the present invention;

FIG. 15 is an enlarged cross-sectional view illustrating a micro convex lens two-dimensional array and a two-dimensional display device viewed from A direction in FIG. 14;

FIG. 16 is an enlarged cross-sectional view illustrating a micro convex lens two-dimensional array and a two-dimensional display device viewed from A direction in FIG. 14;

FIG. 17 is an enlarged cross-sectional view illustrating a micro convex lens two-dimensional array 301 and a two-dimensional display device 302 viewed from A direction in FIG. 14;

FIG. 18 is a cross-sectional view illustrating a position range of a processed object lens with respect to three-dimensional display pixels remote from a main point plane of a lens;

FIG. 19 is a cross-sectional view illustrating a position range of a processed object lens with respect to three-dimensional display pixels near a main point plane of a lens; and

FIG. 20 is a flow chart for explaining a stereoscopic image's element picture preparing display method associated with the embodiment 5 of the present invention.

### DETAILED DESCRIPTION OF PREFERRED EMBODIMENTS

A projection-type three-dimensional display apparatus according to a first invention of the present application comprising a means for controlling and imaging rays of light constituting view point pictures to emit the rays of light constituting the view point pictures including parallax information on view points from a surface of a three-dimensional picture arranged in a space and arranging the view point pictures including a plurality of parallax information on a two-dimensional plane corresponding to the respective imaging means, characterizing by comprising: a means for projecting a group picture of view point pictures including the plurality of parallax information and a screen for imaging the group picture of view point pictures, as a means for arranging the group picture of view point pictures including the plurality of parallax information, which are arranged just behind the means for controlling and imaging the rays of light; a means for detecting the shake of the screen; and a means for correcting and controlling the group picture of view point pictures projected on the screen to a proper position.

According to the above constitution, the projection apparatus and the screen can completely be fixed so that the alignment error of the projection picture and the lens array caused by the vibration of the screen fixed due to a vibration in an installation place can be prevented, thereby realizing a stereoscopic image display apparatus capable of giving reality sense.

In a second invention of the present application, as the means for detecting the shake of the screen, an angular velocity sensor, an acceleration sensor, an image pickup device may be used and a means for detecting the shake of reflected light by reflecting light on the screen may also be used.

In a third invention of the present application, the means for correcting and controlling the group picture to the proper position controls a picture cutout position of the means for projecting the group picture, corrects the projection picture by controlling the projection position of the means for projecting the group picture using an actuator, and corrects the projection picture by controlling the means for projecting the group picture using an optical means.

In a fourth invention of the present application, as the means for controlling and imaging for emitting the element picture including the picture information on the view points, a pinhole array, a convex lens array, a lenticular lens array, and a hologram lens array may be used.

In a fifth invention of the present application, as the projecting means, a transmission-type liquid crystal, a reflective-type liquid crystal, a digital mirror device (DMD), an organic EL luminous body array, and a LED may be used.

In a sixth invention of the present application, as a light source of the projecting means, an organic EL may be used.

In a seventh invention of the present application, as the reflective-type liquid crystal of the projecting means, a reflective-type vertical alignment liquid crystal projection element.

In an eighth invention of the present application, the screen and the means for controlling and imaging the rays of light can be integrated.

In a ninth invention of the present application, a liquid. crystal screen capable of changing the control of the transmittance of the screen in accordance with surrounding brightness can be used.

In a tenth invention of the present application, when the image pickup device is used as the means for detecting the shake of the screen, it is characterized in that it detects an optical flow acquired by the image pickup device through the picture process to detect the direction and amplitude of the shake. Here, the optical flow implies velocity field for each point on the screen.

An eleventh invention of the present application is characterized in that when the means for detecting the shake of the light reflected by reflecting light on the screen is used as the means for detecting the shake of the screen, it uses a two-dimensional positioning sensor as a means for sensing the position of the reflected light using a reflective plate having any angle to an optical axis of light reflected on the screen and having a wedge type of a cross sectional shape.

A twelfth invention of the present application is characterized in that it sequentially selects a three-dimensional display pixel data formed of pixel position information and pixel color information that are components of stereoscopic image to project the shape of the selected three-dimensional display pixel onto a projection region in the display plane of a two-dimensional picture display device so that the element picture of stereoscopic image is prepared or displayed on the two-dimensional picture display device by using the color information on a group of pixels in the projection region as the color information on the three-dimensional display pixel data.

Thereby, a basic process of the stereoscopic image display is based on the number of times of the number of the stereoscopic pixels to reduce the number of times of calculation, compared to a basic process in a conventional method based on the number of times of the number of the two-dimensional pixels.

Also, although the two-dimensional picture display device becomes higher resolution, because of a process to collectively acquire the color information on the two-dimensional display pixel group in the projection region on the display plane of the two-dimensional picture display device of the shape of the three-dimensional display pixel, high resolution can be realized by only the increase of the number of times for writing the color information in a memory as many as the number of pixels without a significant change of the calculating time, not by the increase of the calculating time corresponding to the increase of the number of pixels.

Further, since an uncertain repeat calculation process is not performed, it can always obtain the element picture of stereoscopic image at the same processing time.

In a thirteenth invention of the present application, a stereoscopic image display apparatus having a micro convex lens two-dimensional array and a two-dimensional picture display device installed on a focal plane thereof is characterized in that it sequentially selects a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data.

The stereoscopic image display apparatus has the micro convex lens two-dimensional array and the two-dimensional picture display device installed on a focal plane thereof so that it can prepare and display the element picture of stereoscopic image on the two-dimensional picture display device, thereby always obtaining the a high resolution of the more natural stereoscopic image at the same processing time.

In a fourteenth invention of the present application, a stereoscopic image display apparatus having a pinhole two-dimensional array and a two-dimensional picture display device installed in parallel therewith is characterized in that it sequentially selects a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data.

The stereoscopic image display apparatus has the pinhole two-dimensional array and the two-dimensional picture display device installed in parallel therewith so that it can prepare and display the element picture of stereoscopic image on the two-dimensional picture display device, thereby always obtaining the a high resolution of the more natural stereoscopic image at the same processing time.

In a fifteenth invention of the present application, a stereoscopic image display apparatus having a lenticular lens array and a two-dimensional picture display device installed in parallel therewith is characterized in that it sequentially selects a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data.

The stereoscopic image display apparatus has the lenticular lens array and the two-dimensional picture display device installed in parallel therewith so that it can prepare and display the element picture of stereoscopic image on the two-dimensional picture display device, thereby always obtaining the a high resolution of the more natural stereoscopic image at the same processing time.

In a sixteenth invention of the present application, a stereoscopic image display apparatus having a parallax barrier and a two-dimensional picture display device installed in parallel therewith is characterized in that it sequentially selects a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data.

The stereoscopic image display apparatus has the parallax barrier and the two-dimensional picture display device installed in parallel therewith so that it can prepare and display the element picture of stereoscopic image on the two-dimensional picture display device, thereby always obtaining the a high resolution of the more natural stereoscopic image at the same processing time.

In a seventeenth invention of the present application, a stereoscopic image's element picture preparing display method in a stereoscopic image display apparatus having a micro convex lens two-dimensional array and a two-dimensional picture display device installed on a focal plane thereof and sequentially selecting a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data, is characterized in that it includes the steps of: calculating visible area angles obtained as twice angle as much as arctangent of a ratio that uses a distance between the main point plane of the micro convex lens two-dimensional array and the display plane of the two-dimensional display device as a denominator and a half of a pitch between the convex lenses in the micro convex lens two-dimensional array as a numerator, that is, visible area angles of X direction and Y direction, respectively, with respect to two directions, i.e., X direction and Y direction crossing in the display plane of the two-dimensional display device; and using only the micro convex lenses in an area within a quadrangular pyramid having a main point as the stereoscopic image's element picture calculating object, wherein the pyramid has the selected three-dimensional display pixel position as an apex, the visible area angle in the X direction as an apex angle in the X direction, the visible area angle in the Y direction as an apex angle in the Y direction, and the display plane of the two-dimensional display device as a bottom.

Thereby, since a basic process of the stereoscopic image display is limited to only ones of the entire lenses in the micro convex lens two-dimensional array taking part in the display of the individual three-dimensional display pixels, the reduce of the number of times of calculation can be realized.

In an eighteenth invention of the present application, a stereoscopic image's element picture preparing display method in a stereoscopic image display apparatus having a pinhole two-dimensional array and a two-dimensional picture display device installed in parallel therewith and sequentially selecting a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data is characterized in that it includes the steps of: calculating visible area angles obtained as twice angle as much as arctangent of a ratio that uses a distance between a pinhole plane of the pinhole two-dimensional array and the display plane of the two-dimensional display device as a denominator and a half of a pitch between the pinholes in the pinhole two-dimensional array as a numerator, that is, visible area angles of X direction and Y direction, respectively, with respect to two directions, i.e., X direction and Y direction crossing in the display plane of the two-dimensional display device; and using only the pinholes in an area within a quadrangular pyramid as the stereoscopic image's element picture calculating object, wherein the pyramid has the selected three-dimensional display pixel position as an apex, the visible area angle in the X direction as an apex angle in the X direction, the visible area angle in the Y direction as an apex angle in the Y direction, and the display plane of the two-dimensional display device as a bottom.

Accordingly, since a basic process of the stereoscopic image display is limited to only ones of the entire pinholes in the pinhole two-dimensional array taking part in the display of the individual three-dimensional display pixels, the reduce of the number of times of calculation can be realized.

In an nineteenth invention of the present application, a stereoscopic image's element picture preparing display method in a stereoscopic image display apparatus having a lenticular lens array and a two-dimensional picture display device installed on a focal plane thereof and sequentially selecting a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data is characterized in that it includes the steps of: calculating a visible area angle obtained as twice angle as much as arctangent of a ratio that uses the distance between a main point plane of the lenticular lens array and the display plane of the two-dimensional display device as a denominator and a half of a pitch between the convex lenses of the lenticular lens array as a numerator, with respect to the direction of the pitch between the convex lenses of the lenticular lens array within the display plane of the two-dimensional display device; and using only the lenses in an area of a triangle having a main point as the stereoscopic image's element picture calculating object, wherein in a cross section including the selected three-dimensional display pixel position, being vertical to the display plane of the two-dimensional display device, and having a plane in parallel with the pitch direction between the convex lenses of the lenticular lens array, the triangle has the selected three-dimensional display pixel position as an apex, the visible area angle as an apex angle, and a cross line with the display plane of the two-dimensional display device as a bottom side.

Thereby, since a basic process of the stereoscopic image display is limited to only ones of the entire lenses of the lenticular lens array taking part in the display of the individual three-dimensional display pixels, the reduce of the number of times of calculation can be realized.

In an twentieth invention of the present application, a stereoscopic image's element picture preparing display method in a stereoscopic image display apparatus having a parallax barrier and a two-dimensional picture display device installed in parallel therewith and sequentially selecting a three-dimensional display pixel data formed of pixel position information and pixel color information that are components of stereoscopic image to project the selected three-dimensional display pixel data onto a projection region in the display plane of the two-dimensional picture display device so that the element picture of stereoscopic image is prepared or displayed on the two-dimensional picture display device by using the color information on a group of pixels in the projection region as the color information on the three-dimensional display pixel data is characterized in that it includes the steps of: calculating a visible area angle obtained as twice angle as much as arctangent of a ratio that uses a distance between a barrier plane of the parallax barrier and the display plane of the two-dimensional display device as a denominator and a half of a pitch distance between the slits of the parallax barrier as a numerator, with respect to the direction of a pitch between silts of the parallax barrier within the display plane of the two-dimensional display device; and using only the slits in an area within a triangle having a main point as the stereoscopic image's element picture calculating object, wherein in a section including the selected three-dimensional display pixel position, being vertical to the display plane of the two-dimensional display device, and having a plane in parallel with the pitch direction between the slits of the parallax barrier, the triangle has the selected three-dimensional display pixel position as an apex, the visible area angle as an apex angle, and a cross line with the display plane of the two-dimensional display device as a bottom side.

Thereby, since a basic process of the stereoscopic image display is limited to only ones of the entire slits of the parallax barrier taking part in the display of the individual three-dimensional display pixels, the reduce of the number of times of calculation can be realized.

The twentieth-one invention of the present application performs the preparation and display of the element picture of stereoscopic image on the two-dimensional display device by the stereoscopic image's element picture preparing display method of any one of the first invention to the fourth invention.

The stereoscopic image display apparatus performing the preparation and display of the element picture of stereoscopic image on the two-dimensional display device by the stereoscopic image's element picture preparing display method can be manufactured, thereby always obtaining the a high resolution of the more natural stereoscopic image at the same processing time.

(Embodiment 1)

Hereinafter, a projection-type three-dimensional display apparatus of the present invention will be explained with reference to its practical aspect.

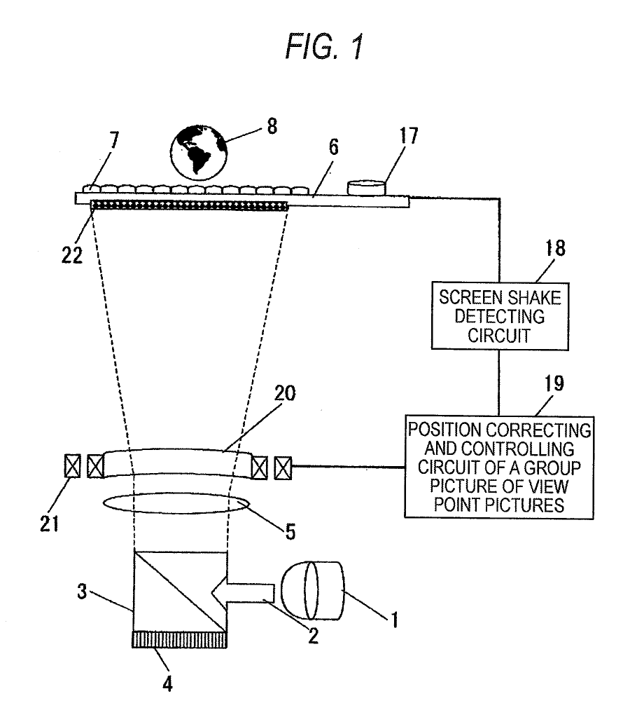

FIG. 1 is a view for explaining the embodiment 1 of the projection-type three-dimensional display apparatus of the present invention. In FIG. 1, after light 2 emitted from a light source 1 is incident on a polarizing beam splitter 3, only S-wave of the light is reflected from an interface of the polarizing beam splitter 3 and is incident on a projecting device 4 as a projecting means for controlling the shape of a projection picture. As the projecting device 4, a direct drive image light amplifier (D-ILA) available from Japanese Victor Co. can be used. The S-wave incident on the projecting device 4 is modulated in the inside of the projecting device 4 by the projection picture information to add the picture information. At this time, since the non-modulated light is reflected as the S-wave and returned to the light source 1 via a path opposite to the incident path, the light is not emitted so that a dark state occurs.

Meanwhile, the modulated S-wave is transformed into light including P-wave components depending on the modulation degree and passes through the polarizing beam splitter 3 so that it is projected on an imaging screen 6 via a projecting lens to image the projection picture. Since the imaged projection picture is a raytrace picture of an integral photography method, a three-dimensional picture 8 can be imaged through a convex lens array 7.

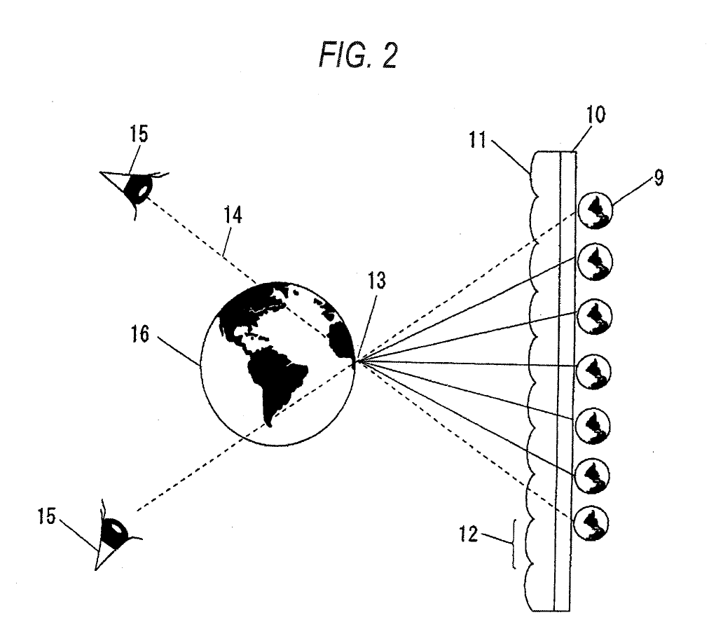

The integral photography method will be in detail herein. FIG. 2 illustrates a principle of the integral photography method. FIG. 2 is a view for explaining the integral photography method. The integral photography was proposed in 1908 by M. G. Lipmann. The integral photography proposed by M. G. Lipmann puts a film on focal position of the convex lens array 11 in the shape of fly's eye to write a picture every the convex lenses 12 in the shape of fly's eye on the surface of the film by using the convex lens array 11 in the shape of fly's eye and in reproducing, reproduces as a stereoscopic picture the picture every the convex lenses 12 written on the surface of the film by using the same convex lens array 11 in the shape of fly's eye as in photographing.

As shown in FIG. 2, when pictures 9 of the reproduced elements are displayed on a display element 10 by corresponding to every the convex lenses 12 in the convex lens array 11 in the shape of fly's eye, in order to allow the pictures 9 of the reproduced elements to be imaged on a imaging point 13 corresponding to a pixel position of an original picture surface via the convex lens 12, an viewer actually reproduces a three-dimensionally reproduced picture 16 by a ray of light 14, which is generated from the imaging point 13, incident on his pupil 15. Since the three-dimensionally reproduced picture 16 actually has the imaging point 13 in a space, the viewer can stably view the three-dimensionally reproduced picture 16 regardless of the change of angle and the movement of eye position.

As the light source 1 used in the projection-type three-dimensional display apparatus of the present invention, a halogen lamp has been used. As other light sources, a LED for each color or an organic EL may be used. In particular, a white LED is optimally used as a substitute for the halogen lamp.

The convex lens 12 of the present invention would use a lens of 12 mm in diameter. The resolution of the projection picture projected and imaged on the imaging screen 6 is 200 dpi. Thereby, the picture 9 of the reproduced element is formed of a picture of 10×10 pixels so that the number of parallax in horizontal and vertical directions each can reproduce a smooth three-dimensional stereoscopic picture of 10 fields of vision. If the resolution of the imaged projection picture is 200 dpi or less, it is difficult to obtain a naturally reproduced stereoscopic picture. Despite being traded-off with a data processing time, in order to obtain a natural three-dimensional stereoscopic picture as well as possible it is advantageous in reproducing the picture of the reproduced element 9 with the resolution of 200 to 700 dpi by the lens of 1.5 mm or less.

As a means for detecting the shake of the imaging screen 6, an angular velocity sensor 17, for example, using Coriolis' force is installed to measure angular velocities of X-axis, Y-axis and Z-axis on the imaging screen 6. If the angular velocity sensor 17 detects the shake of the imaging screen 6, the screen shake detecting circuit 18 detects the signal to calculate the direction and amplitude strength of the shake and transfers the results to a position correcting and controlling circuit 19 of a group picture of view point pictures. The position correcting and controlling circuit 19 of the group picture of view point outputs a proper correction signal from the data about the direction and amplitude strength of the shake. The output signal is transferred to a position controller 21 for moving a correcting lens 20 so that the correcting lens 20 is moved to a surface direction vertical to a projection optical axis.

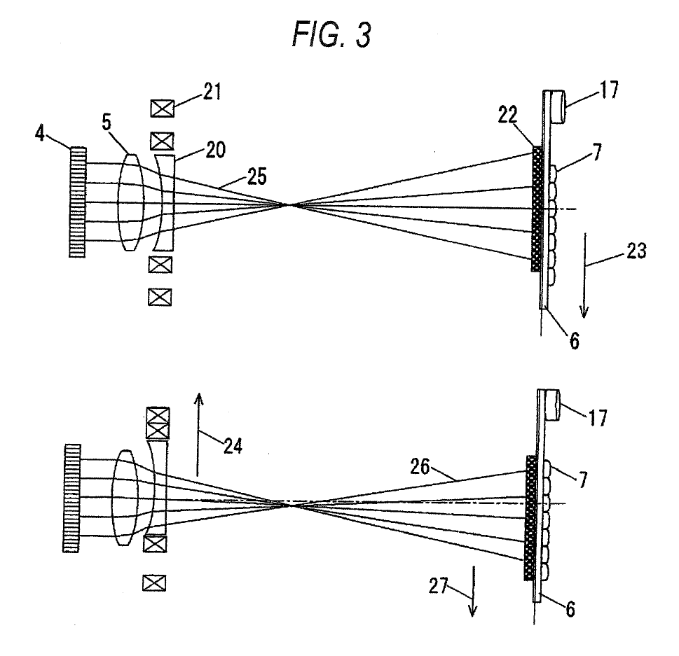

An optical means for adjusting a ray of light by moving a portion of a lens according to the present invention will be explained with reference to FIG. 3.

When the raytrace picture 22 of the integral photography method is imaged on a space through the convex lens array 7 by projecting the picture information from the projecting device 4 on the imaging screen 6 via the projecting lens 5, the imaging screen 6 shakes to a shaking direction 23 by external vibration to cause the alignment deviation of the convex lens array 7 and the raytrace picture 22, thereby degrading picture quality. In order to correct the alignment error, the direction and amplitude of the shake are detected by the angular velocity sensor 17 mounted on the imaging screen 16 detects and then transferred to the position controller 21 via the screen shake detecting circuit 18 and the position correcting and controlling circuit 19 of the group picture of view point pictures so that the position controller 21 moves the correcting lens 20 to a correcting lens position controlling direction 24. By this operation, a non-controlled ray of light 25 in a state that there is the alignment deviation of the convex lens array 7 and the raytrace picture 22 can be changed to a controlled ray of light 26. Thereby, the raytrace picture 22 is moved to a control direction 27 to correct the alignment of the convex lens array 7 and the raytrace picture 22.

(Embodiment 2)

Hereinafter, a projection-type three-dimensional display apparatus will be explained with reference to an embodiment 2 of the present invention.

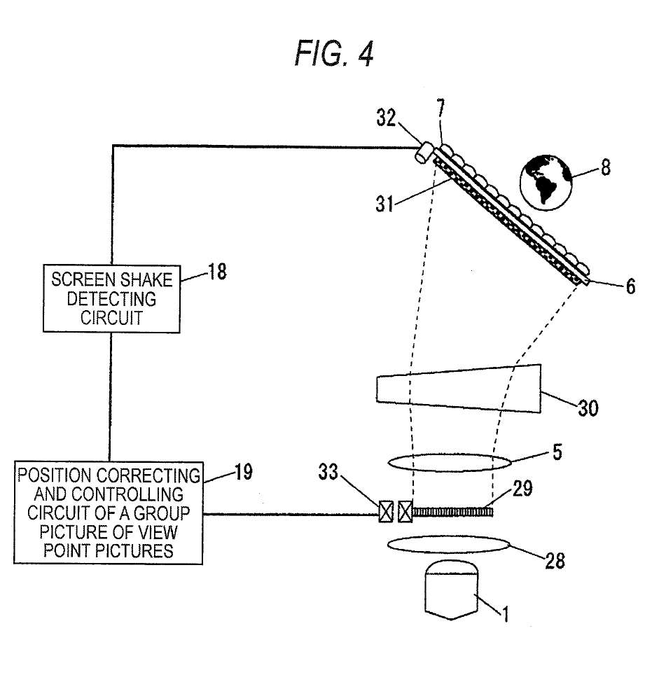

FIG. 4 is a view for explaining an embodiment 2 of a projection-type three-dimensional display apparatus of the present invention. In FIG. 4, light emitted from the light source 1 is light-collected by a condenser lens 28 to be incident on a transmission-type projecting device 29 as a projecting means for controlling a shape of a projection picture. As the transmission-type projecting device 29, a transmission-type liquid crystal may by used. The light incident on the transmission-type projecting device 29 is modulated by projection picture information in the inside thereof to add the picture information. The modulated light passes through a projecting lens 5 to be incident on a prism 30 for changing its projection angle and is then projected on an imaging screen 6 so that a projection picture 31 is imaged. Since the projection picture 31 is a raytrace picture of an integral photography method, it can be imaged in a space through a convex lens array 7 as a three-dimensional image 8. Since a projection plane is changed by passing through the prism, it can obtain the large degree of freedom for the design of a stereoscopic reproducing apparatus.

As the light source 1 used in the projection-type three-dimensional display apparatus of the present invention in FIG. 4, a white LED has been used. As other light sources, a LED for each color, an organic EL or a halogen lamp may be used.

The convex lens 12 of the present invention would use a lens of 12 mm in diameter, as in the embodiment 1. The resolution of the projection picture projected and imaged on the imaging screen 6 is 200 dpi. Thereby, the picture 9 of the reproduced element is formed of a picture of 10×10 pixels so that the number of parallax in horizontal and vertical directions each can reproduce a smooth three-dimensional stereoscopic picture of 10 fields of vision. If the resolution of the imaged projection picture is 200 dpi or less, it is difficult to obtain a naturally reproduced stereoscopic picture. Despite being traded-off with a data processing time, in order to obtain a natural three-dimensional stereoscopic picture as well as possible it is advantageous in reproducing the picture of the reproduced element 9 with the resolution of 200 to 700 dpi by the lens of 1.5 mm or less.

As a means for detecting the shake of the imaging screen 6, a screen shake detecting circuit 18 receives a surrounding picture from an image pickup element 32 mounted on the imaging screen 6 to time-serially process the picture so that it detects velocity field every pixels called optical flow to statistically process it and then calculate the direction and amplitude of the whole shake of the imaging screen 6.

The results are transferred to a position correcting and controlling circuit 19 of a group picture of view point pictures. The position correcting and controlling circuit 19 of the group picture of view point pictures outputs a proper correction signal from the data about the direction and amplitude strength of the shake. The output signal is transferred to a position controller 33 for moving a transmission-type projecting device 29 so that the transmission-type projecting device 29 is moved to a surface direction vertical to a projection optical axis.

By this operation, a ray of light can be changed to a ray of light not having a state that the alignment of the convex lens array 7 and the projection picture is deviated. Thereby, since the raytrace picture 31 is moved to the shaking direction of the screen, the alignment of the convex lens array 7 and the projection picture 31 is corrected.

As a result, the misalignment of the projection apparatus and the screen is prevented so that the vibration of the screen due to vibration in an installation place and the alignment deviation of the projection picture and the lens array can be prevented, thereby realizing a projection-type three-dimensional picture reproducing apparatus capable of giving reality sense as well as increasing three-dimensional effect due to the improvement of resolution and picture quality in the space projection of the three-dimensional picture display.

(Embodiment 3)

Next, a projection-type three-dimensional display apparatus will be with reference to Embodiment 3 of the present invention.

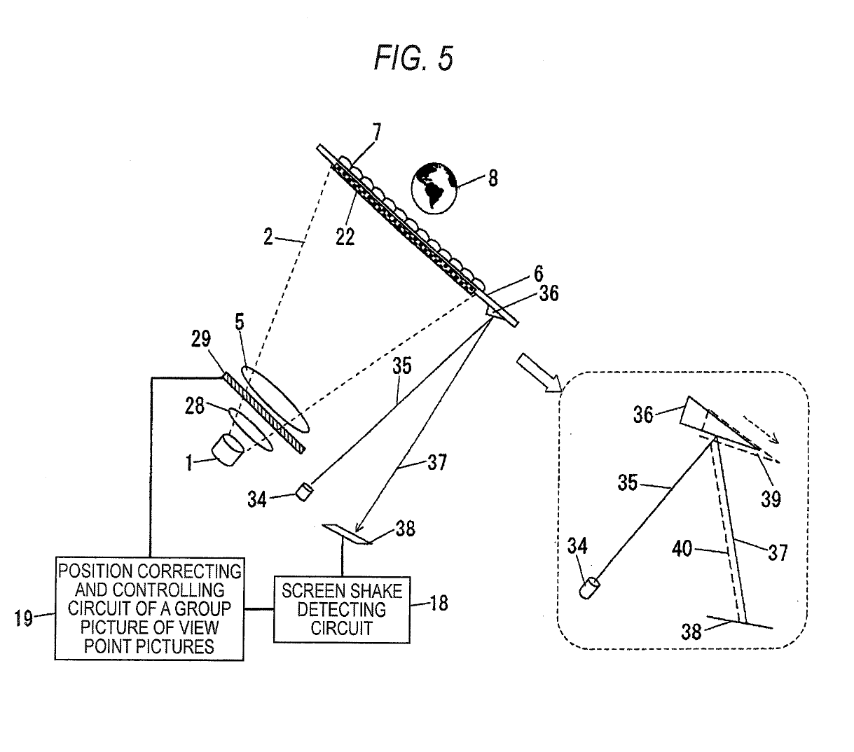

FIG. 5 is a view for explaining the embodiment 3 of the projection-type three-dimensional display apparatus of the present invention.

In FIG. 5, light emitted from the light source 1 is light-collected by a condenser lens 28 to be incident on a transmission-type projecting device 29 as a projecting means for controlling a shape of a projection picture. As the transmission-type projecting device 29, a transmission-type liquid crystal may by used. The light incident on the transmission-type projecting device 29 is modulated by projection picture information in the inside thereof to add the picture information. The modulated light is projected on an imaging screen 6 via a projecting lens 5 to image a projection picture 31. Since the imaged projection picture 31 is a raytrace picture of an integral photography method, it can be imaged in a space through a convex lens array 7 as a three-dimensional image 8.

As the light source 1 used in the projection-type three-dimensional display apparatus of the present invention in FIG. 5, a white LED has been used. As other light sources, a LED for each color, an organic EL or a halogen lamp may be used.

The convex lens 12 of the present invention would use a lens of 12 mm in diameter, as in the embodiment 1. The resolution of the projection picture projected and imaged on the imaging screen 6 is 200 dpi. Thereby, the picture 9 of the reproduced element is formed of a picture of 10 by 10 pixels so that the number of parallax in horizontal and vertical directions, respectively, can reproduce a smooth three-dimensional stereoscopic picture of 10 fields of vision. If the resolution of the imaged projection picture is 200 dpi or less, it is difficult to obtain a naturally reproduced stereoscopic picture. Despite being traded-off with a data processing time, in order to obtain a natural three-dimensional stereoscopic picture as well as possible it is advantageous in reproducing the picture of the reproduced element 9 with the resolution of 200 to 700 dpi by the lens of 1.5 mm or less.

As a means for detecting the shake of the imaging screen 6, there has been used a means for detecting the shake of a reflected light 37 by reflecting light from a wedge-type reflective plate 36 on the imaging screen 6 using a more directional light than a light source 34 having directivity as an incident light 35. Further, as a means for sensing the reflected light, there has been used a two-dimensional positioning sensor 38 as a means for sensing the position of the reflected light using a reflective plate 36 having any angle to an optical axis of light reflected on the imaging screen 6 and having a cross sectional shape of a wedge-type, as illustrated in FIG. 5. As the two-dimensional positioning sensor 38, a two-dimensional position detecting element (PSD) available from HAMAMATSU PHOTONICS Co. may be used.

In an enlarged view for illustrating the relation of the wedge-type reflective plate 36, the incident light 35, and the reflected light 37 in FIG. 5, with respect to the position of the two-dimensional positioning sensor 38 for the reflected light 37 of the light 35 incident on the position of the wedge-type reflective plate 46 denoted by a solid line, since the position that after the wedge-type reflective plate is moved due to the shake of the imaging screen 6, the light 40 reflected from the position of the wedge-type reflective plate 39 denoted by a dotted line is reached to the two-dimensional positioning sensor 38 is correlated with the movement distance of the imaging screen 6, it is possible to measure the movement distance of the imaging screen 6 by a predefined formula.

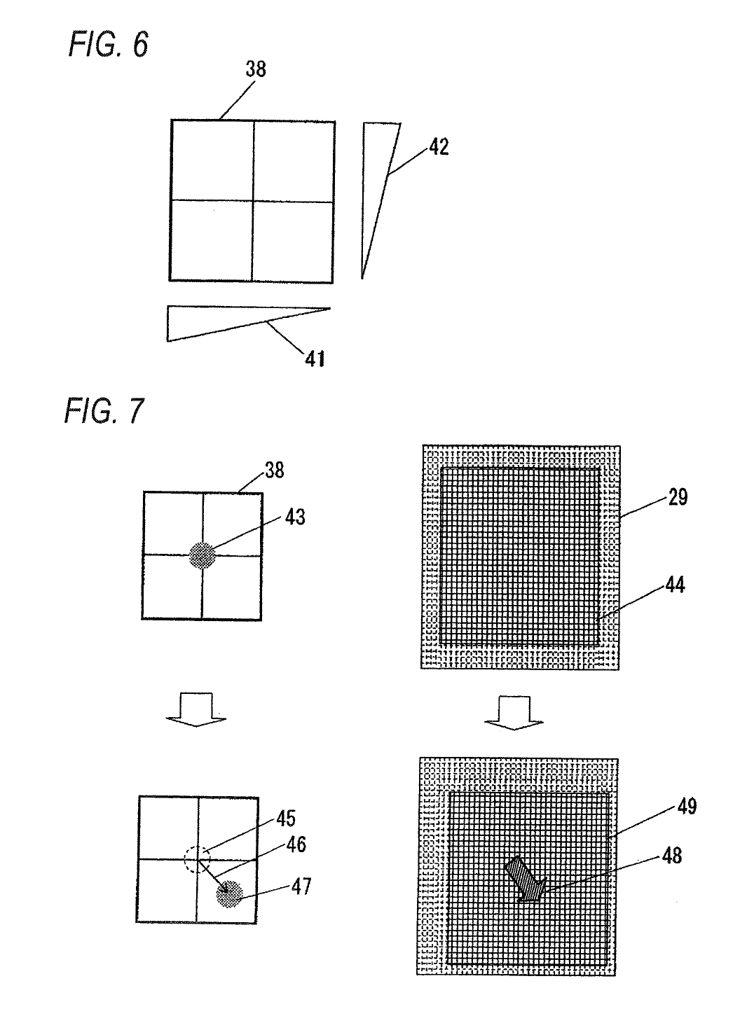

FIG. 6 is a view for explaining the shape of the wedge-type reflective plate of the present invention. In order to measure the three-dimensional movement distance by the reflected position, a wedge structure of the reflective plate for independent two directions, respectively, is needed. For example, the reflective plate for the shape 41 of X-axis direction and the shape 42 of Y-axis direction having the same slope should be manufactured as illustrated in FIG. 6.

FIG. 7 is a view for explaining a principle adjusting a ray of light by the wedge-type reflective plate and the projecting device.

First, the position of the spot 43 of the light 37 reflected from the wedge-type reflective plate 36 mounted on the imaging screen 6 in a stop state is positioned at the central of the two-dimensional positioning sensor 38. In the state, the transmission-type projecting device 29 projects the raytrace picture 22 on the imaging screen 6 by using the central region 44 having a non-display region around the device as illustrated in FIG. 7. If the positions of the imaging screen 6 and the convex lens array 7 are changed by the shake, the original spot 45 positioned at the central is moved to the shaking direction 46, thereby creating a new spot 47. The two-dimensional positioning sensor 30 detects the position to move the central region 44 having a non-display region around the device to the position of a vector direction 48 previously correlated with the shaking direction 46 so that the moved region becomes a modified display region 49.

As a result, the misalignment of the projection apparatus and the screen is prevented so that the vibration of the screen due to vibration in an installation place and the alignment deviation of the projection picture and the lens array can be prevented, thereby realizing a projection-type three-dimensional picture reproducing apparatus capable of giving reality sense as well as increasing three-dimensional effect due to the improvement of the resolution and picture quality in the space projection of the three-dimensional picture display.

The stereoscopic image reproducing apparatus of the present invention can be used as a three-dimensional display stereoscopic image reproducing apparatus used in an image technology field, an amusement field, an entertainment field, an internet field, an information field, a multimedia field, a communication field, an advertisement and propaganda field, a medical field, an art field, an education field, a design supporting field, a simulation field, a virtual reality field, and the like.

(Embodiment 4)

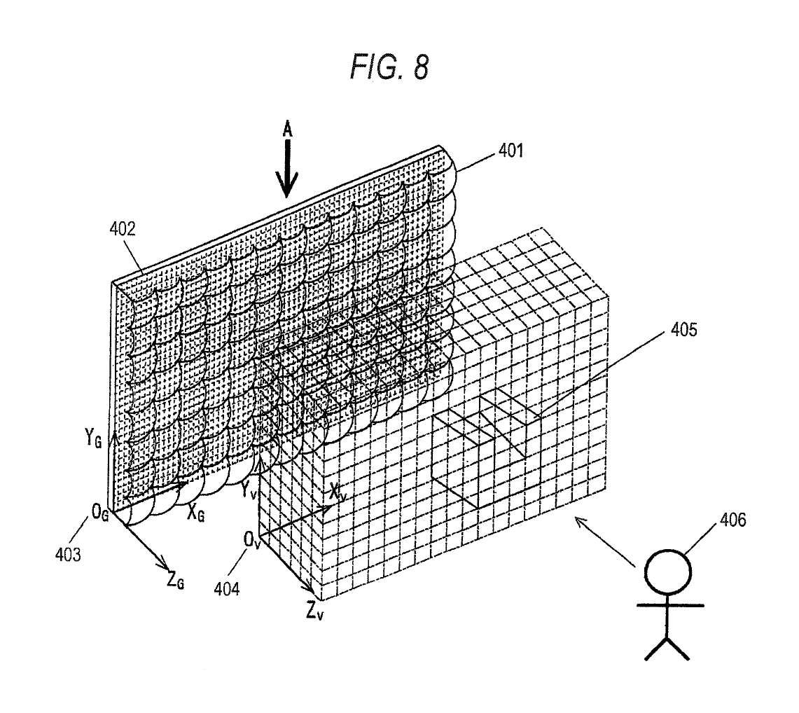

FIG. 8 is a view for explaining a stereoscopic image display apparatus according to the stereoscopic image's element picture preparing display method of Embodiment 4. As illustrated in FIG. 8, the stereoscopic image display apparatus according to the embodiment 4 has a micro convex lens two-dimensional array 401 and a two-dimensional picture display device 402.

The micro convex lens two-dimensional array 401 has a function to change the direction of a ray of light emitted from the two-dimensional picture display device 402 to a direction according to a pixel position. In addition, in the embodiment 4 the micro convex lens two-dimensional array 401 may also be used in a pinhole two-dimensional array. Further, if the micro convex lens two-dimensional array 401 is used only in one parallax direction, the micro convex lens two-dimensional array 401 may also be used in a lenticular lens or a parallax barrier. When the pinhole two-dimensional array, the lenticular lens or the parallax barrier is used as the micro convex lens two-dimensional array 401, the two-dimensional picture display device 402 should be arranged in parallel therewith.

The two-dimensional picture display device 402 is installed on the focal plane of the micro convex lens two-dimensional array 401 and has a function to emit the ray of light as the source of the stereoscopic image to the micro convex lens two-dimensional array 401. In addition, as the two-dimensional picture display device 401 the combination of a print sheet in a film or a printer and a plane light source or a display screen in a liquid crystal display or a projector can be used. Further, when emitting the ray of light to the micro convex lens two-dimensional array 401 by the reflected light from an viewer, not by the emission from the rear, the two-dimensional display device 402 can be uses as a print media of simply film, a printer or an offset print, etc.

In the stereoscopic image display apparatus according to the embodiment 4, in order to display the stereoscopic image 405 on any space, an origin point 404 of the three-dimensional display pixel (hereinafter, referred to as a voxel) for displaying the stereoscopic image 405 as a set of minute cuboids and an origin point 403 on global coordinates positioned on the two-dimensional picture display device 402 for displaying the entire position relation of the apparatus are defined.

The viewer 406 observes the direction of the two-dimensional picture display device 402 from the micro convex lens two-dimensional array 401 with respect to the two-dimensional picture display device 402. Here, if the viewer is positioned parallel with the display plane of the two-dimensional picture display device 402, the horizontal direction becomes X direction and the vertical direction Y-direction, and if the viewer is positioned vertical to the display plane of the two-dimensional picture display device 402, the direction from the display plane of the two-dimensional picture display device 402 to the micro convex lens two-dimensional array 401 becomes Z direction.

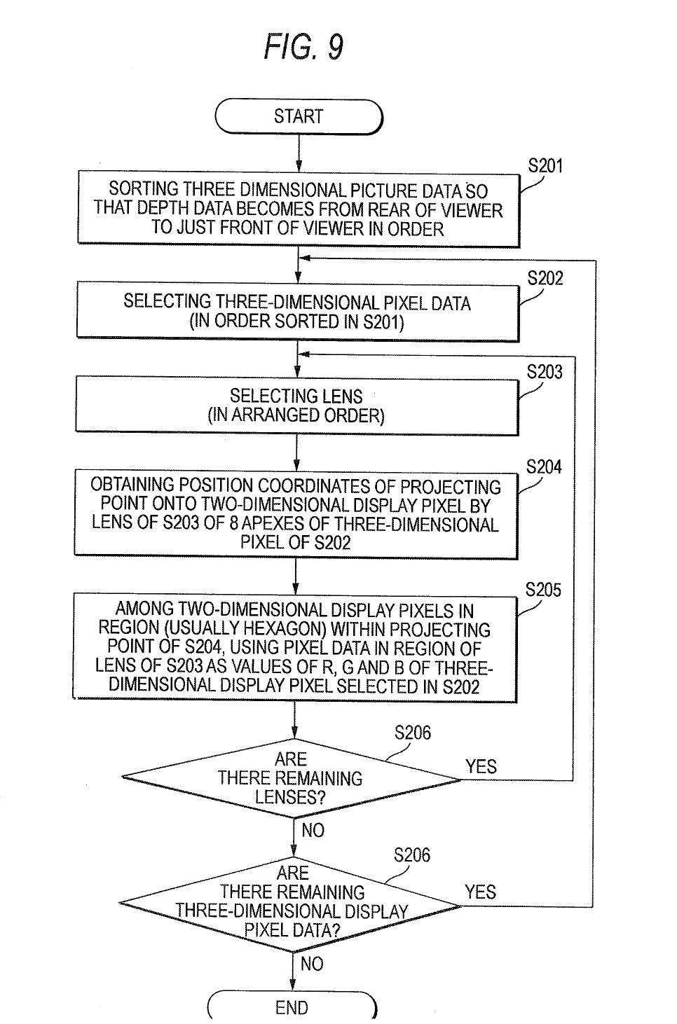

The stereoscopic image's element picture preparing method according to the embodiment 4 will be explained with reference to FIG. 9. FIG. 9 is a flow chart illustrating the process of the stereoscopic image's element picture preparing method according to the embodiment 4 of the present invention.

First, each voxel data is sorted in the order of depth data components. In the case of the embodiment 4, the voxel data are enumerated in an ascending order again to sort them from rear of the viewer to just front of the viewer (S201 process).

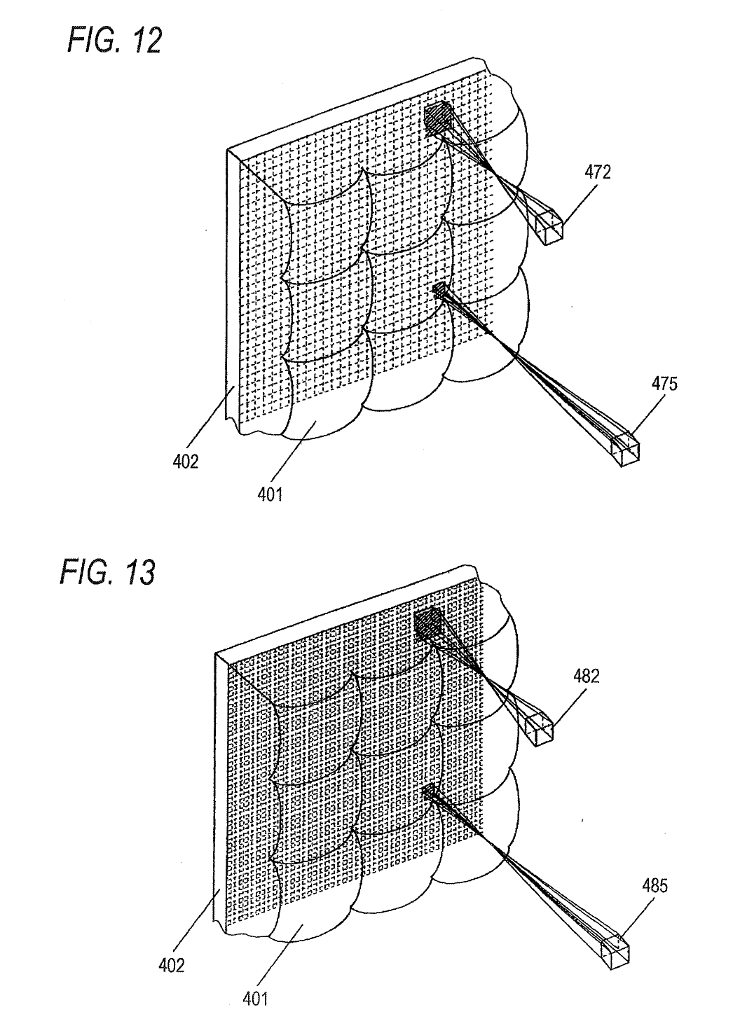

Next, the lens reproducing the ray of light is selected (S203 process) among the micro convex lens two-dimensional array 401 by selecting one voxel data in the sorted order (S202 process). In the case of the embodiment 4, since each voxel is a cube (although denoted by reference numerals 472, 475 in FIG. 12 and reference numerals 482, 485 in FIG. 13, the detailed description thereof will be made below), the voxel data are a set of each coordinate data with 8 apexes and color data.

Next, each straight line binding the respective 8 apexes of the voxel data selected in the S202 and the main point of the lens selected in the S203 is extended to obtain intersection points of the extended straight lines and the display plane of the two-dimensional picture display device 2 (S204 process). The region projected on the display plane of the two-dimensional picture display device 2 formed by the 8 intersection points becomes usually a hexagon. That is, at least two of the 8 apexes are projected on the region binding other 6 apexes. If the voxel selected in the S202 faces off the lens selected in the S203, the region projected on the display plane of the two-dimensional picture display device 2 becomes a regular square.

Among the regions projected on the display plane of the two-dimensional picture display device 402, the values of the R, G and B of the color information data of the two-dimensional display pixel group within the region of the lens selected in the S203 are used as the values of the R, G and B of color information of the voxel data selected in the S202.

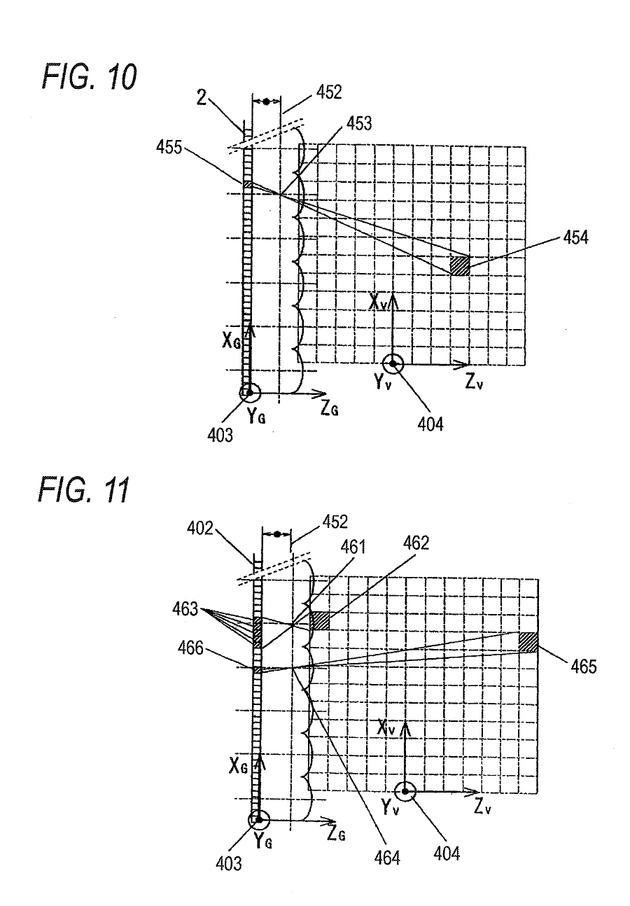

Here, the process contents of the S204 and the S205 will be described in detail with reference to FIG. 10 and FIG. 11. FIG.10 and FIG. 11 are cross-sectional views seen from A direction of FIG. 8.

First, in FIG. 10, a straight line is drawn from each apex of the cross section 453 of the voxel to the main point 453 of the lens to obtain the intersection point with the two-dimensional picture display device 202 so that the two-dimensional display pixels 455 can be obtained as the projection region of the cross section 454 of the voxel. Next, as illustrated in FIG. 11, two cross sections 462, 465 of voxels having a different depth data, that is, the different value of Z data, are compared. If the projection region on the display plane of the two-dimensional picture display device 402 in the main point 461 of the lens with respect to the cross section 462 of the voxel and the main point 464 of the lens with respect to the cross section 465 of the voxel, respectively, is obtained, a two-dimensional display pixel group 463 as many as 5 pixels and a two-dimensional display pixels 466 originally having only the projection region less than one pixel are obtained.

As appreciated from FIG. 11, although the size of the voxels is the same, as the voxel is near the main point plane 452 of the lens, the projection region becomes larger, and as the voxel is remote from the main point plane 452 of the lens, the projection region becomes smaller.

Therefore, in the process according to the S205, as the voxel is near the main point of the lens, the same color information data (for example, R, G and B) can be written in the plurality of the two-dimensional pixels in a lump.

Further, in a batch writing process into the plurality of the two-dimensional pixels as in the S205, since the quantity of calculation for calculating the coordinates of the projecting points on the display plane of the two-dimensional picture display device 402 calculated from the 8 apexes of the selected voxles is constant independently of the size of the projection regions, the increase of processing time due to the increase of the number of pixels in the two-dimensional pixel group ends in only the increase of time writing the values of the R, G and B of the color information data into a memory. In the S205, since the writing time into the memory is usually insignificant compared to the processing time for calculating the projection coordinates indicated in the S202 to the S204, although the resolution on the surface of the two-dimensional picture display device 402 is increased, the overall processing time indicated in FIG. 9 is not so large.

Hereinafter, it checks whether or not there are the remaining lenses in S206 and then checks whether or not there are the remaining voxel data in S207 so that they is subjected to the same processes in order.

The number of times of a repeat process from the S202 to the S207 becomes generally the number of times of the number of pixels of the voxel smaller than that the number of pixels of the two-dimensional display. Further, the processes indicated in the S202 to the S204 (the processes for calculating the coordinates of the projecting points on the display plane of the two-dimensional picture display device 402 from the 8 apexes of the respective selected voxles) can previously be formulated rather than a search process in which the number of times of repeat is not specified so that a high speed process such as a parallel process, etc., can easily be achieved. Thereby, the processing time can further be shortened.

Next, it is compared with a calculation processing time when the high resolution of the two-dimensional picture display device 402 is used in order to improve the picture quality of the stereoscopic picture. In a conventional method, since the number of pixels of the two-dimensional display becomes basically the number of times of necessary processes, when the number of pixels doubles by using the high resolution of the two-dimensional picture display device, the calculation processing time is simply doubled. However, the stereoscopic image's element picture preparing method according to the embodiment 4 uses the number of pixels (the number of voxels) of the three-dimensional display as the number of times of basically necessary processes and is able to perform a batch writing process into the two-dimensional display pixel group in the projection region on the display plane of the two-dimensional picture display device from the one voxel data.

This is illustrated in FIG. 12 and FIG. 13. FIG. 13 illustrates the display state of the two-dimensional display pixel when using the high resolution of the two-dimensional picture display device 402 having the number of pixels of double in length and breadth and four times in area, compared to FIG. 2. The voxel 472 and the voxel 482 near the main point of the lens and the voxel 475 and the voxel 485 remote from the main point of the lens are compared. The projection region onto the display plane of the two-dimensional picture display device 402 of the each voxel shape becomes a hexagon having the same size and shape as the cases of FIG. 12 and FIG. 13, as shown in a solid line.

In addition, the projection regions denoted by a solid line in FIG. 12 and FIG. 13 are virtually illustrated for explaining the calculation results of the position coordinates of the projecting points performed in the internal process upon rendering and are not actually displayed on the two-dimensional picture display device 402. In actual, the projection regions are displayed with the colors of the values of R, G and B of the color information data of the each voxel corresponding to the group of pixels in an oblique line. Only the difference between FIG. 12 and FIG. 13 is that the number of pixels in the projection region due to the difference in size of the two-dimensional display pixels included in the projection region of the hexagon differs. Thereby, if the number of the two-dimensional pixels increases, since the quantity of the calculation for calculating the coordinates of the projecting points on the two-dimensional picture display device 402 of the voxel is constant independently of the size of the projection regions, the increase of processing time due to the increase of the number of pixels in the two-dimensional pixel group ends in only the increase of time writing the values of the R, G and B of the color information data into a memory. Since the writing time into the memory is insignificant compared to the processing time for calculating the projection coordinates, the increase of the calculating time due to the increase of the number of pixels of the two-dimensional picture display device 2 is not so large. From the above description, the stereoscopic image's element picture preparing display method according to the embodiment 4 is advantageous in both high resolution and high speed process, compared to the conventional method.

As described above, according to the stereoscopic image's element picture preparing display method of the embodiment 4 of the present invention, since the number of times of basically necessary processes in the stereoscopic image display is the number of the stereoscopic pixels (the number of voxels), so that the number of times of the calculation can be realized compared to the conventional method using the number of times of the number of the two-dimensional pixels as a basic process.

Also, although the two-dimensional picture display device 402 becomes higher resolution, because of a process to collectively acquire the color information on the two-dimensional display pixel group in the projection region on the display plane of the two-dimensional picture display device of the shape of the three-dimensional display pixel, high resolution can be realized by only the increase of the number of times for writing the color information in a memory as many as the number of pixels without the increase of the calculating time, not by the increase of the calculating time corresponding to the increase of the number of pixels.

Further, since an uncertain repeat calculation process is not performed, it can always obtain the element picture of stereoscopic image at the same processing time. In addition, it can always obtain the high resolution of the more natural stereoscopic image at the same processing time.

In addition, in the embodiment 4, although the case having parallax of two directions like the micro convex lens two-dimensional array is described, in the case of parallax having only one direction like the lenticular lens array or the parallax barrier, since it is considered that there is the cross section having the number of pixels of the three-dimensional display (the number of voxels) in a direction not causing parallax, that is, a vertical direction, as illustrated in FIG. 10 and FIG. 11, the same effects can be obtained.

As described above, since the stereoscopic image's element picture preparing method according to the present invention has the effects of both high resolution and high speed process when displaying the stereoscopic picture from the three-dimensional display pixel data, for example, a service providing a stereoscopic display apparatus or a stereoscopic picture and a stereoscopic picture receiving terminal used in the service, a hologram display apparatus, a dedicated hologram CAD for a building and a design, a stereoscopic picture creating software operated in a computer, and the like.

(Embodiment 5)

Hereinafter, a stereoscopic image's element picture preparing method according to an embodiment 5 will be explained with reference to the drawings.

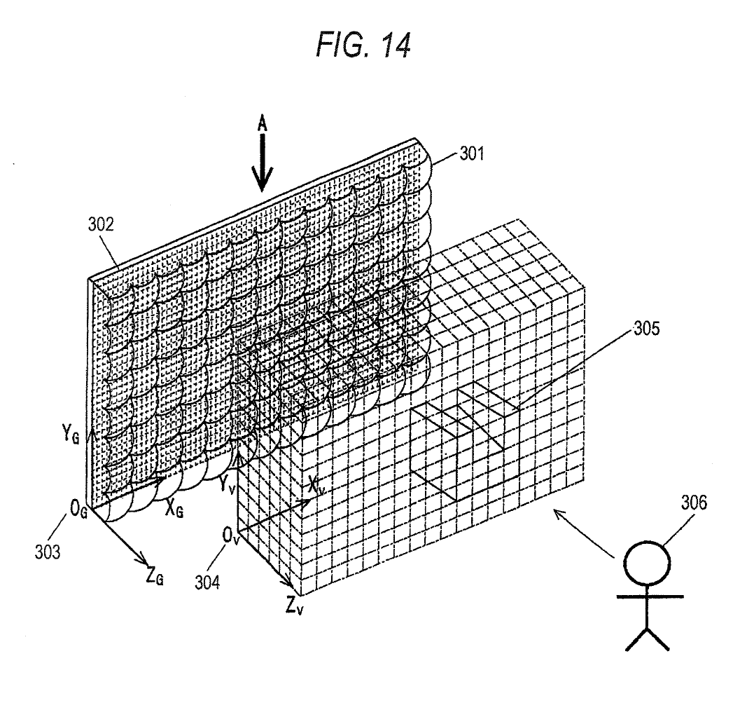

FIG. 14 is a view for explaining a stereoscopic image display apparatus according to the stereoscopic image's element picture preparing display method of the embodiment 5. As illustrated in FIG. 14, the stereoscopic image display apparatus according to the embodiment 5 has a micro convex lens two-dimensional array 301 and a two-dimensional picture display device 302.

The micro convex lens two-dimensional array 301 has a function to change the direction of a ray of light emitted from the two-dimensional picture display device 302 to a direction according to a pixel position. In addition, in the embodiment 5 the micro convex lens two-dimensional array 301 may also be used in a pinhole two-dimensional array. Further, if the micro convex lens two-dimensional array 301 is used only in parallax direction, the micro convex lens two-dimensional array 301 may also be used in a lenticular lens or a parallax barrier. When the pinhole two-dimension array, the lenticular lens or the parallax barrier is used as the micro convex lens two-dimensional array 401, the two-dimensional picture display device 402 should be arranged in parallel with the lenticular lens or the parallax barrier.

The two-dimensional picture display device 302 is installed on the focal plane of the micro convex lens two-dimensional array 301 and has a function to emit the ray of light as the source of the stereoscopic image to the micro convex lens two-dimensional array 301. In addition, as the two-dimensional picture display device 301 the combination of a print sheet in a film or a printer and a plane light source or a display screen in a liquid crystal display or a projector can be used. Further, when emitting the ray of light to the micro convex lens two-dimensional array 301 by the reflected light from an viewer, not by the emission from the rear, the two-dimensional display device 302 can be uses as a print media of simply film, a printer or an offset print, etc.

In the stereoscopic image display apparatus according to the embodiment 5, in order to display the stereoscopic image 305 on any space, an origin point 304 of the three-dimensional display pixel (hereinafter, referred to as a voxel) for displaying the stereoscopic image as a set of minute cuboids and an origin point 303 on global coordinates positioned on the two-dimensional picture display device 302 for displaying the entire position relation of the apparatus are defined.

The viewer observes the direction of the two-dimensional picture display device 302 from the micro convex lens two-dimensional array 301 with respect to the two-dimensional picture display device 302. Here, if the viewer is positioned parallel with the display plane of the two-dimensional picture display device 302, the horizontal direction becomes X direction and the vertical direction Y-direction, and if the viewer is positioned vertical to the display plane of the two-dimensional picture display device 302, the direction from the display plane of the two-dimensional picture display device 302 to the micro convex lens two-dimensional array 301 becomes Z direction.

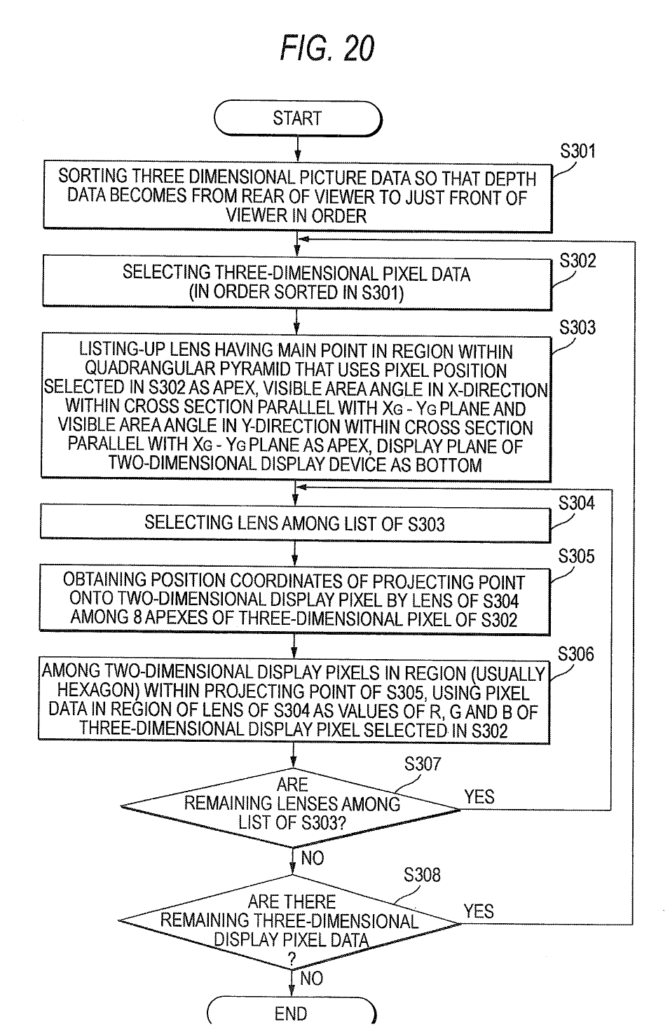

The stereoscopic image's element picture preparing method according to the embodiment 5 will be explained with reference to FIG. 20. FIG. 20 is a flow chart illustrating the process of the stereoscopic image's element picture preparing method according to the embodiment 5 of the present invention.

First, each voxel data is sorted in the order of depth data components. In the case of the embodiment 5, the voxel data are enumerated in an ascending order again to sort them from rear of the viewer to just front of the viewer (S301 process).

Next, the one voxel data in the sorted order is selected (S302 process), and a lens used for displaying the three-dimensional pixels of the voxel data is listed-up (S303 process). The limitation on a processed object lens by the list-up will be explained in detail below.

Next, the lens is selected among the listed-up list in the S303 process. Each straight line binding the respective 8 apexes of the voxel data selected in the S302 and the main point of the lens selected in the S303 is extended to obtain intersection points of the extended straight lines and the display plane of the two-dimensional picture display device (S304 process). The region projected on the display plane of the two-dimensional picture display device formed by the 8 intersection points becomes usually a hexagon. That is, at least two of the 8 apexes of the voxel data are projected in the region binding other 6 apexes. If the voxel selected in the S302 faces off the lens selected in the S303, the region projected on the display plane of the two-dimensional picture display device becomes a regular square. Among the regions projected on the display plane of the two-dimensional picture display device, the values of the R, G and B of the color information data of the two-dimensional display pixel group within the region of the lens selected in the S303 are used as the values of the R, G and B of color information of the voxel data selected in the S302. After processing the entire lenses listed-up in the S303, it judges whether there are the remaining three-dimensional display pixels (S308 process) and if there are, it returns to the S202 to select subsequently three-dimensional display pixels and then perform a repeat process in order.

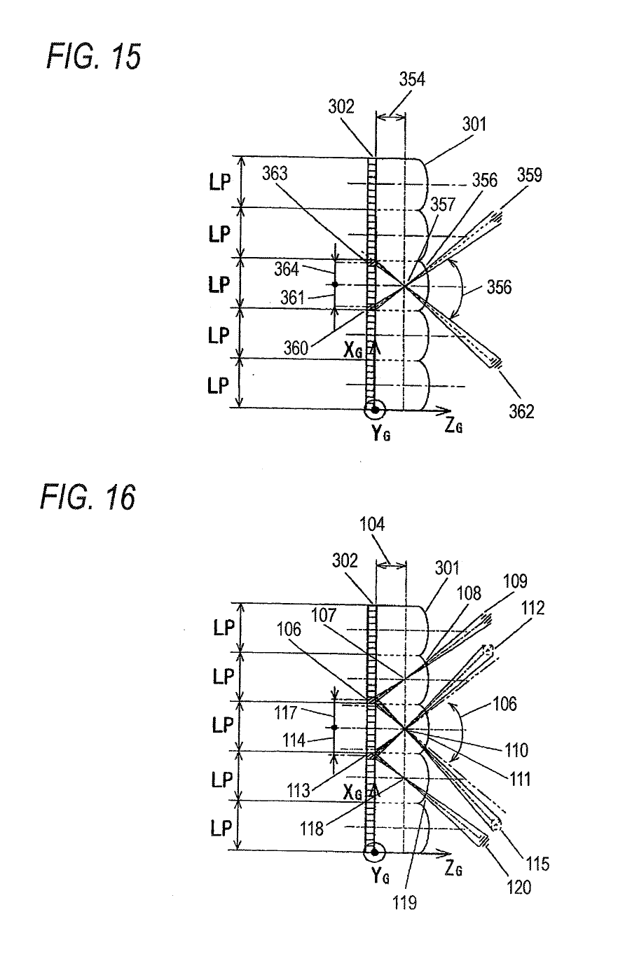

Here, in order to explain the list-up process performed by the S302, a visible area angle will first be explained with reference to FIG. 15 and FIG. 16. FIG. 15 and FIG. 16 are enlarged cross-sectional views of the micro convex lens two-dimensional array 301 and the two-dimensional display device 302 viewed from A direction.

First, as illustrated in FIG. 15, upon paying attention to one lens in the micro convex lens two-dimensional array 301, a two-dimensional device pixel 360 and a two- dimensional display pixel 363 farthest away from the central of the lens among the pixels of the two-dimensional display device 2 in a pitch LP between the convex lenses take part in the display of the three-dimensional display pixels of a largest viewing angle direction among the three-dimensional display pixels reproducible by a lens 358. Here, the viewing angle is referred to as an angle forming a viewing direction by setting the direction that a viewer parallel with Z_{G}-axis straightly views the micro convex lens two-dimensional array 301 to 0.

A three-dimensional display pixel (voxel) 362 is reproduced in a straight direction binding a main point 357 that becomes the central of the lens 358 and a two-dimensional display pixel 363. Likewise, a three-dimensional display pixel (voxel) 359 is displayed in a straight direction binding the main point 357 of the lens 358 and a two-dimensional display pixel 360. Within the range of an angle formed by the two straight lines, that is, the straight line binding the two-dimensional display picture 360 and the main point 357 of the lens and the straight line binding the two-dimensional display pixel 363 and the main point 357, the three-dimensional display pixel can be displayed by the lens 358. This angle 357 is referred to as the visible area angle.

Contrary to this, the case of the pixel of the two-dimensional display device outside the pitch LP between the convex lenses will be explained with reference to FIG. 16. As illustrated in FIG. 16, since the two-dimensional display pixel 116 outside the pitch LP between the convex lenses exists within the pitch LP between the convex lenses of a lens 108 adjacent to a lens 111, within the range of the visible area angle 365 described in FIG. 15 it takes part in the display of the three-dimensional pixel from the lens 108. That is, it takes part in the three-dimensional display pixel of the straight direction binding the two-dimensional display pixel 116 and the main point 107 of the lens, for example, the display of the three-dimensional display picture (voxel) 109 in FIG. 16. Certainly, upon widening a viewing direction outside the range of the visible area angle 356 (see FIG. 15), it can also take part in the pixel of the straight direction binding the two-dimensional display pixel 116 and the main point 10 in the micro convex lens two-dimensional array, for example, the display of the three-dimensional display pixel (voxel) 115 in FIG. 16. However, upon widening the viewing direction until the direction as described above, since it overlaps the two-dimensional pixel in the region of the adjacent lens, the element picture cannot be prepared. Likewise, in the case that the two-dimensional display pixel 113 is outside the pitch LP between the convex lenses of the lens 111 in an opposite direction to the two-dimensional display pixel 116, it can take part in the display of the three-dimensional display pixel 120 of the straight direction binding the lens 111 and the main point 118 of the adjacent lens 119 rather than in the three-dimensional display pixel 112 of the straight direction binding the two-dimensional display pixel 113 and the main point 110 of the lens in the micro convex lens two-dimensional array of the lens 111.

As described above with reference to FIG. 15 and FIG. 16, in order to prepare the stereoscopic image's element picture so that the interference between individual lenses in the micro convex lens two-dimensional array 301, that is, the overlap of the pixels in the regions of the lenses adjacent to each other, is not caused, the pixel must exist in the pitch LP between the convex lenses. Therefore, it is necessary for the distance from the main point of the lens to the two-dimensional display pixel to be smaller than the pitch LP between the convex lenses. From this, upon considering that the size of the two-dimensional display pixel becomes an infinitesimal extreme value, the visible area angle is obtained as twice angle as much as arctangent of a ratio that uses a half of the pitch LP between the convex lenses array as a numerator and the distance between the main point of the micro convex lens two-dimensional array 301 and the display plane of the two-dimensional display device 302 as a denominator

In case of FIG. 15, on the two-dimensional display device 302, a distance 364 of X_{G} direction from the main point of the lens 358 to the two-dimensional display pixel 363 and a distance 61 of X_{G} direction from the main point 357 of the lens 358 to the two-dimensional display pixel 360 is to be smaller than the half of the pitch LP between the convex lenses. From this, it can be judged that the two-dimensional display pixel 360 and the two-dimensional display pixel 363 are within the visible area angle of the lens 358. Further, the visible area angle 356 can be calculated by obtaining twice the arctangent of the ratio of dividing the half of the pitch LP between the convex lenses by the distance 354 between the main point plane of the micro convex lens two-dimensional array 301 and the display plane of the two-dimensional display device 302.

In case of FIG. 16, on the two-dimensional display device 302, a distance 117 of X_{G} direction from the main point of the lens in the micro convex lens two-dimensional array of the lens 111 to the two-dimensional display pixel 363 and a distance 114 of X_{G} direction from the main point 110 of the lens in the micro convex lens two-dimensional array of the lens 111 of the two-dimensional display pixel 113 to the two-dimensional display pixel 111 is to be smaller than the half of the pitch LP between the convex lenses. From this, it can be judged that the two-dimensional display pixel 113 and the two-dimensional display pixel 116 are outside the visible area angle of the lens 111.

Further, likewise the case of FIG. 15, the visible area angle of the lens 111 can be calculated by obtaining twice the arctangent of the ratio of dividing the half of the pitch LP between the convex lenses by the distance 104 between the main point plane of the micro convex lens two-dimensional array land the display plane of the two-dimensional display device 302. The S303 process in FIG. 20 is a process to previously calculate the visible area angle and list-up only the lens taking part in the display of the selected three-dimensional display pixel.

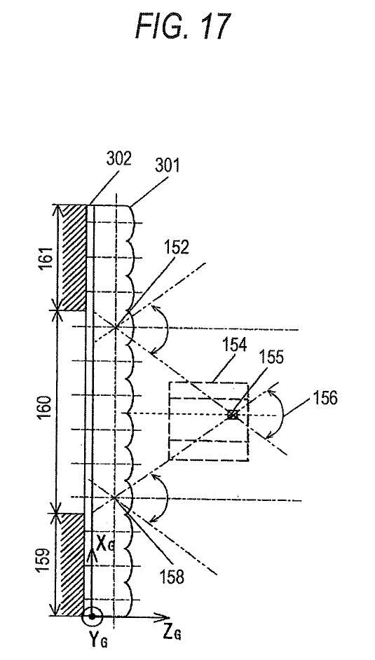

Next, a method for obtaining a lens capable of taking part in the display of the selected three-dimensional display pixel from the previously calculated visible area angle will be described. FIG. 17 is an enlarged cross-sectional view of the micro convex lens two-dimensional array 301 and the two-dimensional display device 302 viewed from A direction in FIG. 14.

First, consider the case that a three-dimensional display pixel 155 among displayed stereoscopic images 154 is selected. A lens including the three-dimensional display pixel 155 within a visible area angle includes the three-dimensional display pixel 155 within a triangle that uses the main point of the lens, the bottom side of the triangle parallel with X_{G}-axis, and a visible area angle as an apex angle. Contrary to this, the lens having the main point of the lens within the triangle that uses the selected three-dimensional display pixel 155 as an apex, the bottom side of the triangle parallel with X_{G}-axis, and the visible area angle as an apex angle is the lens capable of taking part in the display of the three-dimensional display pixel 155.

In FIG. 17, the main point of the lens within the triangle that uses the three-dimensional display pixel 155 as an apex, the bottom side of the triangle parallel with X_{G}-axis, and the visible area angle 156 as an apex angle is 152 to 158. That is, in FIG. 17 the region 160 of the lens having the main point within a quadrangular pyramid that uses the three-dimensional display pixel (voxel) 155 as an apex, the visible area angle 156 as an apex angle, and the main point plane of the micro convex lens two-dimensional array las a bottom is the region of the lens capable of taking part in the display of the three-dimensional display pixel 155, and the regions 159, 161 of the lens not having the main point within a quadrangular pyramid that uses the three-dimensional display pixel (voxel) 155 as an apex, the visible area angle as an apex angle, and the main point plane of the micro convex lens two-dimensional array las a bottom are the regions of the lens capable of not taking part in the display of the three-dimensional display pixel 155.

FIG. 17 is a cross-sectional view of a side parallel with X_{G}-Z_{G} plane; however, FIG. 17 can also consider a cross section parallel with Y_{G}-Z_{G} plane going straight to the side. Here, if the visible area angle of the cross section of the side parallel with the X_{G}-Z_{G} plane is referred to as a visible area angle in X-direction and a visible area angle of the cross section of the side parallel with the Y_{G}-Z_{G} plane is referred to as a visible area angle in Y-direction, the lens taking part in the display of the selected three-dimensional display pixel in the micro convex lens two-dimensional array 301 may be called a micro convex lens having a main point within a quadrangular pyramid that uses the position of the selected three-dimensional display pixel as an apex, the apex angle in the X-direction as a pre-calculated visible area angle in X-direction, the apex angle in the Y-direction as a pre-calculated visible area angle as an apex angle in Y-direction, and the display plane of the two-dimensional display device as a bottom.

Further, in the case that the pinhole two-dimensional array is used instead of the micro convex lens array 301, upon substituting the position of the pinhole with the main point of the lens, the structures using the pinhole two-dimensional array is completely identical with that of the micro convex lens array 301.

In addition, upon considering a cross section of one direction, that is, only the X_{G}-direction rather than both directions of the X_{G}-direction and the Y_{G}-direction as illustrated in FIG. 17, the correspondence of the micro convex lens two-dimensional array 1 to the main point of the lens is substituted for the position of the lenticular lens array and the main point of the lens and the position of the parallax barrier and the slit.

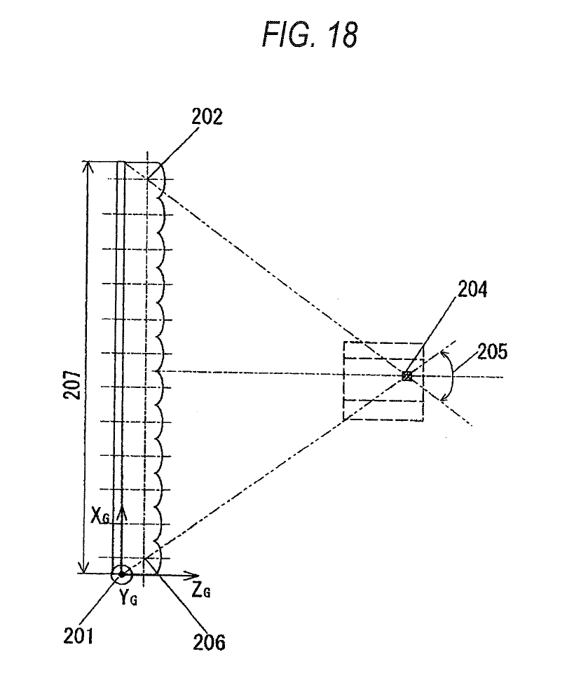

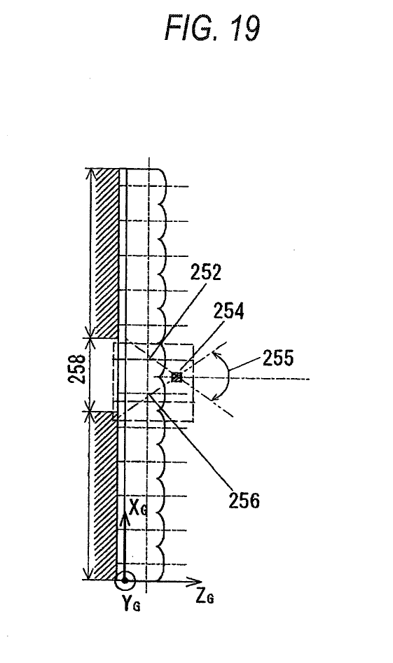

Finally, in order to explain the reduced effect of the quantity of calculation according to the present invention, a difference in the number of lenses taking part in the reproduction of the pixels due to the difference in the positions of the selected three-dimensional display pixels will be explained with reference to FIG. 18 and FIG. 19. FIG. 18 is a cross-sectional view illustrating a position range of a processed object lens for the three-dimensional display pixel remote from the main point plane of the lens. FIG. 19 is a cross-sectional view illustrating a position range of a processed object lens for the three-dimensional display pixel near the main point plane of the lens.

FIG. 18 illustrates the case of a three-dimensional display pixel 204 remote from the main point plane of the lens. In this case, the entire lenses from a lens 201 to a lens 202, that is, lenses in a region 207 of a lens having a main point within a quadrangular pyramid that uses a three-dimensional display pixel (voxel) 204 as an apex, a visible area angle 205 as an apex angle, the main point plane of the micro convex lens two-dimensional array las a bottom are lenses taking part in the reproduction of the pixel. In other words, the lenses are listed-up and objected lenses.

FIG. 19 illustrates the case of a three-dimensional display pixel 254 near the main point plane of the lens. In this case, lenses of a lens 252 and a lens 256, that is, only lenses in a region 258 of a lens having a main point within a quadrangular pyramid that uses a three-dimensional display pixel (voxel) 254 as an apex, a visible area angle 255 as an apex angle, the main point plane of the micro convex lens two-dimensional array as a bottom are lenses taking part in the reproduction of the pixel. In other words, the twelve lenses in FIG. 18 and the two lenses in FIG. 19 are lenses capable of taking part in the display of the selected three-dimensional display pixel.

Assuming that the X_{G}-direction is completely identical with the Y_{G}-direction, in FIG. 18, the lenses of 12×12=144 is the number of lenses taking part in the reproduction of the selected three-dimensional pixel 204 and thus, requires the calculation process 144 times. Likewise, upon considering the case of FIG. 19, the lenses of 2×2=4 is the number of lenses taking part in the reproduction of the selected three-dimensional display pixel 254 and thus, requires only the calculation process four times. In the process of the conventional stereoscopic image's element picture preparing display method, a loop calculation process is performed 144 times. However, according to the process of FIG. 20 to which the present invention is applied, in the case of FIG. 18 the process is performed 144 times and in the case of FIG. 19 the process is performed four times.

From the above description, it can be appreciated that in the case of requiring the calculation process as in FIG. 18, the process is performed and in the case of not requiring the calculation process as in FIG. 19, the unnecessary processes are reduced. Upon considering FIG. 19, throughput is only 3% as 4÷144≈0.03. Further, the reduced processes are for the lens clearly not taking part in the reproduction of the three-dimensional display pixel so that the degradation of picture quality is never generated.

In the case that the lens or the pinhole is in the lenticular lens array or the parallax barrier array which is a one-dimensional arrangement rather than a two-dimensional array, throughput ends in the process of 17% from 2÷12≈0.17, as illustrated in the example of FIG. 19.

In the stereoscopic image display apparatus of the integral photography method, since the stereoscopic image by the group of pixels near the main point plane of the lens has the highest spatial resolution and is suitable for being displayed as a high definition of stereoscopic image, there are many cases that the pixel near the main point plane of the lens occupies most of the stereoscopic images displayed. For this reason, in most of the three-dimensional pixels constituting the stereoscopic image displayed, the reduced effect can be expected as in FIG. 10.

Further, in order to display a stereoscopic image having a large amount of movement, even if a large area of the micro convex lens array having a larger number of lenses is used by enlarging the display area of the stereoscopic image, the process is performed only on the lens taking part in the display of the selected three-dimensional display pixel so that if the size of the displayed stereoscopic image and the dimension of the pitch between the lenses are the same, the increase of calculating time is not caused due to the increase of the number of lenses.

For example, in two stereoscopic image display apparatuses using the micro convex lens two-dimensional array of the same lens pitch, in order to take a large amount of movement of the stereoscopic image, a use example of the micro convex lens two-dimensional array of which the dimensions of height are the same and the dimension of width in transversal direction as movement direction of the stereoscopic image becomes twice is considered.

According to the conventional method, as the number of lenses becomes twice, the number of times of calculation becomes twice. However, according to the embodiment 5 of the present invention, when the size of the moving stereoscopic image is constant, the number of lenses taking part in the reduction of the stereoscopic image is constant so that even if the micro convex lens two-dimensional array of twice in the number of lenses is used, the number of times of calculation remains constant.

In other words, even if the number of lenses is increased in order to improve the picture quality of the stereoscopic image, in the stereoscopic image's element preparing process, since it previously obtains the lenses in the region taking part in the display of the three-dimensional display pixel every the three-dimensional display pixels selected to limit only the lenses to a processed object, an unnecessary process of the lenses not taking part in the display of the three-dimensional pixel that has been performed according to the stereoscopic image's element picture preparing display method of the conventional stereoscopic image display apparatus is reduced so that both effects of a high picture quality and a high speed process can be achieved.

As described above, since the stereoscopic image's element picture preparing method according to the present invention has the effects of both high resolution and high speed process when displaying the stereoscopic picture from the three-dimensional display pixel data, for example, a service providing a stereoscopic display apparatus or a stereoscopic picture and a stereoscopic picture receiving terminal used in the service, a hologram display apparatus, a dedicated hologram CAD for a building and a design, a stereoscopic picture creating software operated in a computer, and the like.

What is claimed is:

1. A projection-type three-dimensional display apparatus comprising means for controlling and imaging rays of light constituting view point pictures to emit the rays of light constituting the view point pictures including parallax information on view points from a surface of a three-dimensional picture arranged in a space, wherein the view point pictures including the plurality of parallax information are arranged on a two-dimensional plane corresponding to the respective imaging means, the projection-type three-dimensional display apparatus comprising:
means for projecting a group picture of the view point pictures including the plurality of parallax information and a screen for imaging the group picture of view point pictures, as a means for arranging the group picture of view point pictures including the plurality of parallax information, which are arranged just behind the means for controlling and imaging the rays of light;
means for detecting the shake of the screen; and
means for correcting and controlling the group picture of view point pictures projected on the screen to a proper position.

2. The projection-type three-dimensional display apparatus according to claim 1,
wherein as the means for detecting the shake of the screen, an angular velocity sensor is used.

3. The projection-type three-dimensional display apparatus according to claim 1,
wherein as the means for detecting the shake of the screen, an acceleration sensor is used.

4. The projection-type three-dimensional display apparatus according to claim 1,
wherein as the means for detecting the shake of the screen, an image pickup device is used.

5. The projection-type three-dimensional display apparatus according to claim 1,
wherein as the means for detecting the shake of the screen, a means for detecting the shake of reflected light which is reflected on the screen is used.

6. The projection-type three-dimensional display apparatus according to claim 1,
wherein the means for correcting and controlling the group picture to the proper position controls a picture cutout position of the means for projecting the group picture.

7. The projection-type three-dimensional display apparatus according to claim 1,
wherein the means for correcting and controlling the group picture to the proper position corrects the projection picture by controlling the projection position of the means for projecting the group picture using an actuator.

8. The projection-type three-dimensional display apparatus according to claim 1,
wherein the means for correcting and controlling the group picture to the proper position corrects the projection picture by controlling the means for projecting the group picture using an optical means.

9. The projection-type three-dimensional display apparatus according to claim 1,
wherein as the means for controlling and imaging for emitting the element picture including the picture information on the view points, a pinhole array is used.

10. The projection-type three-dimensional display apparatus according to claim 1,
wherein as the means for controlling and imaging for emitting the element picture including the picture information on the view points, a convex lens array is used.

11. The projection-type three-dimensional display apparatus according to claim 1,
wherein as the means for controlling and imaging for emitting the element picture including the picture information on the view points, a lenticular lens array is used.

12. The projection-type three-dimensional display apparatus according to claim 1,
wherein as the means for controlling and imaging for emitting the element picture including the picture information on the view points, a hologram lens array is used.

13. The projection-type three-dimensional display apparatus according to claim 1,
wherein as the projecting means, a transmission-type liquid crystal is used.

14. The projection-type three-dimensional display apparatus according to claim 1,
wherein as the projecting means, a reflective-type liquid crystal is used.

15. The projection-type three-dimensional display apparatus according to claim 1,
wherein as the projecting means, a digital mirror device (DMD) is used.

16. The projection-type three-dimensional display apparatus according to claim 1,
wherein as the projecting means, an organic EL luminous body array is used.

17. The projection-type three-dimensional display apparatus according to claim 16,
wherein as a light source of the projecting means, a LED is used.

18. The projection-type three-dimensional display apparatus according to claim 1,
wherein as a light source of the projecting means, an organic EL is used.

19. The projection-type three-dimensional display apparatus according to claims 1,
wherein as the reflective-type liquid crystal of the projecting means, a reflective-type vertical alignment liquid crystal projection element is used.

20. The projection-type three-dimensional display apparatus according to claim 1,
wherein the screen and the means for controlling and imaging the rays of light are integrated.

21. The projection-type three-dimensional display apparatus according to claim 1,
wherein a liquid crystal screen capable of changing the control of the transmittance of the screen in accordance with surrounding brightness is used.

22. The projection-type three-dimensional display apparatus according to claim 1,
wherein when the image pickup device is used as the means for detecting the shake of the screen, it detects an optical flow of the screen acquired by the image pickup device through the picture process to detect the direction and amplitude of the shake.

23. The projection-type three-dimensional display apparatus according to claim 1,
wherein when the means for detecting the shake of the light reflected by reflecting light on the screen is used as the means for detecting the shake of the screen, it uses a two-dimensional positioning sensor as means for sensing the position of the reflected light using a reflective plate whose cross sectional shape is wedge shape and which has any angle to an optical axis of light reflected on the screen.
